(19) United States
(12) Patent Application Publication
(10) Pub. No.: US 2026/0208363 A1
(43) Pub. Date: Jul. 23, 2026

(54) APPARATUS AND METHOD WITH ROBOT ARM CONTROL

(71) Applicant: Samsung Electronics Co., Ltd., Suwon-si (KR)

(72) Inventors: Gunhee KOO, Suwon-si (KR); Jiyeoup JEONG, Suwon-si (KR); Yonggonjong PARK, Suwon-si (KR)

(73) Assignee: Samsung Electronics Co., Ltd., Suwon-si (KR)

(21) Appl. No.: 19/301,593

(22) Filed: Aug. 15, 2025

(30) Foreign Application Priority Data
Jan. 23, 2025 (KR) 10-2025-0010615

(51) Int. Cl. B25J 9/16; B25J 19/02

(52) U.S. Cl. CPC B25J 9/1697; B25J 9/161; B25J 9/1661; B25J 19/021

(57) ABSTRACT

An apparatus configured to receive an image of a robot arm and an end-effector, a point cloud of each of pixels indicating the robot arm, and a control instruction to control the robot arm to perform a target task, the device rendering a scene from a virtual viewpoint in a virtual space by using the image and the point cloud to generate a first rendering image, generate a first heatmap image for estimating a target position of the end-effector to perform the target task, determine a target magnification by using a magnification determination model, generate a second rendering image, generate a second heatmap image for estimating the target position of the end-effector to perform the target task by a second heatmap generation model receiving the second rendering image, and control the robot arm by estimating the target position to perform the target task using the second heatmap image.

### CROSS-REFERENCE TO RELATED APPLICATIONS

This application claims the benefit under 35 USC § 119(a) of Korean Patent Application No. 10-2025-0010615, filed on Jan. 23, 2025, in the Korean Intellectual Property Office, the entire disclosure of which is incorporated herein by reference for all purposes.

### BACKGROUND

### 1. Field

The following description relates to an apparatus and method with robot arm control using a magnification determination model.

### 2. Description of Related Art

A robot arm may be used to perform various tasks. Robot arms may be used in various fields such as automobile assembly, sorting and packaging of goods, surgical assistance, and maintenance and repair of artificial satellites. For a robot arm to perform a requested task, a motion plan based on hard coding or a motion plan obtained from a trained machine learning model based on deep learning may be used. Since a machine learning model may be trained to perform various tasks, a robot arm based on a machine learning model may provide versatility for a wide variety of tasks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an apparatus including at least one processor including processing circuitry, communication circuitry configured to receive, from an image sensor, an image of a robot arm including an end-effector, a point cloud including points indicating a three-dimensional (3D) coordinate of each of pixels indicating the robot arm in the image, and a control instruction to control the robot arm to perform a target task, and a memory including one or more storage media storing instructions that, when executed individually or collectively by the at least one processor, cause the device to render a scene in which the robot arm is viewed from a virtual viewpoint in a virtual space by using the image and the point cloud to generate a first rendering image, generate a first heatmap image for estimating a target position of the end-effector to perform the target task by a first heatmap generation model receiving the first rendering image and the control instruction, determine a target magnification indicating a degree to which a region of interest (ROI) associated with the target task is magnified in the first rendering image by using a magnification determination model receiving the first heatmap image, generate a second rendering image in which the ROI is magnified and rendered by applying the target magnification to the ROI of the first rendering image, generate a second heatmap image for estimating the target position of the end-effector to perform the target task by a second heatmap generation model receiving the second rendering image, and control the robot arm by estimating the target position to perform the target task using the second heatmap image.

The execution of the instructions may causes the apparatus to generate probability values for each of different candidate magnifications by the magnification determination model and determine, to be the target magnification, a candidate magnification having a largest probability value among the probability values for each of the different candidate magnifications.

The execution of the instructions may causes the apparatus to generate the first heatmap image and a first feature point, the first feature point being a 3D coordinate corresponding to a maximum value among color values of the first heatmap image, by the first heatmap generation model, generate the second heatmap image and a second feature point, the second feature point being a 3D coordinate corresponding to a maximum value among color values of the second heatmap image, by the second heatmap generation model receiving the second rendering image and the first feature point, and control the robot arm by estimating the target position to perform the target task using the second heatmap image and the second feature point.

The image sensor may include a first image sensor configured to obtain a first image by capturing the robot arm in a first direction, a second image sensor configured to obtain a second image by capturing the robot arm in a second direction, and a third image sensor configured to obtain a third image by capturing the robot arm in a third direction, the first heatmap generation model may be configured to output the first heatmap image and the first feature point based on a first color value of a two-dimensional (2D) heatmap image corresponding to a first rendered image obtained by rendering the first image, a second color value of a 2D heatmap image corresponding to a second rendered image obtained by rendering the second image, and a third color value of a 2D heatmap image corresponding to a third rendered image obtained by rendering the third image, and the second heatmap generation model may be configured to output the second heatmap image and the second feature point based on a first heatmap color value of a first heatmap image for a first rendering image generated by applying the target magnification to the ROI of the image obtained by rendering the first image, a second heatmap color value of a second heatmap image for a second rendering image generated by applying the target magnification to the ROI of the image obtained by rendering the second image, and a third heatmap color value of a third heatmap image for a third rendering image generated by applying the target magnification to the ROI of the image obtained by rendering the third image.

The end-effector may include a gripper configured to manipulate an object on which the target task is to be performed and the execution of the instructions may cause the apparatus to generate the second heatmap image, the second feature point, control data on whether to start an operation of the gripper, and control data on a rotational operation of the gripper by the second heatmap generation model.

The rotational operation may include a rotational operation for at least one of roll, pitch, and yaw and a rotation angle included in the control data on the rotational operation of the gripper may be one of predefined rotation angles.

The execution of the instructions may causes the apparatus to control the robot arm to position the gripper at the second feature point when the control data on whether to start the operation of the gripper indicates an on state indicating an operation start of the gripper.

The execution of the instructions may causes the apparatus to perform the target task by rotating the gripper based on the control data on the rotational operation of the gripper.

The magnification determination model may be a model trained to output the target magnification by a reinforcement learning method.

In a general aspect, here is provided a processor-implemented method including receiving an image, from an image sensor, of a robot arm including an end-effector that, a point cloud including points indicating a three-dimensional (3D) coordinate of each of pixels indicating the robot arm in the image, and a control instruction to control the robot arm to perform a target task, rendering a scene in which the robot arm is viewed from a virtual viewpoint in a virtual space by using the image and the point cloud to generate a first rendering image, generating a first heatmap image for estimating a target position of the end-effector to perform the target task in the first rendering image by a first heatmap generation model receiving the first rendering image and the control instruction, determining a target magnification indicating a degree to which a region of interest (ROI) associated with the target task is magnified in the first rendering image by using a magnification determination model receiving the first heatmap image, generating a second rendering image in which the ROI is magnified and rendered by applying the target magnification to the ROI of the first rendering image, generating a second heatmap image for estimating the target position of the end-effector to perform the target task in the second rendering image by a second heatmap generation model receiving the second rendering image, and controlling the robot arm by estimating the target position to perform the target task using the second heatmap image.

The determining of the target magnification may include generating probability values for each of different candidate magnifications by the magnification determination model and determining, to be the target magnification, a candidate magnification having a largest probability value among the probability values for each of the different candidate magnifications.

The first heatmap image may include generating the first heatmap image and a first feature point, the first feature point being a 3D coordinate corresponding to a maximum value among color values of the first heatmap image, by the first heatmap generation model, the generating of the second heatmap image may include generating the second heatmap image and a second feature point, the second point feature being a 3D coordinate corresponding to a maximum value among color values of the second heatmap image, by the second heatmap generation model receiving the second rendering image and the first feature point, and the controlling of the robot arm to perform the target task may include controlling the robot arm by estimating the target position to perform the target task using the second heatmap image and the second feature point.

The image sensor may include a first image sensor configured to obtain a first image by capturing the robot arm in a first direction, a second image sensor configured to obtain a second image by capturing the robot arm in a second direction, and a third image sensor configured to obtain a third image by capturing the robot arm in a third direction, the first heatmap generation model may be configured to output the first heatmap image and the first feature point based on a first color value of a two-dimensional (2D) heatmap image corresponding to a first rendered image obtained by rendering the first image, a second color value of a 2D heatmap image corresponding to a second rendered image obtained by rendering the second image, and a third color value of a 2D heatmap image corresponding to a third rendered image obtained by rendering the third image, and the second heatmap generation model may be configured to output the second heatmap image and the second feature point based on a first heatmap color value of a first heatmap image for a first rendering image generated by applying the target magnification to the ROI of the image obtained by rendering the first image, a second heatmap color value of a second heatmap image for a second rendering image generated by applying the target magnification to the ROI of the image obtained by rendering the second image, and a third heatmap color value of a third heatmap image for a third rendering image generated by applying the target magnification to the ROI of the image obtained by rendering the third image.

The end-effector may include a gripper configured to manipulate an object on which the target task is to be performed and the generating of the second heatmap image may include generating the second heatmap image, the second feature point, control data on whether to start an operation of the gripper, and control data on a rotational operation of the gripper by the second heatmap generation model.

The rotational operation may include a rotational operation for at least one of roll, pitch, and yaw and a rotation angle included in the control data on the rotational operation of the may be one of predefined rotation angles.

The controlling of the robot arm to perform the target task may include controlling the robot arm to position the gripper at the second feature point when the control data on whether to start the operation of the gripper indicates an on state indicating an operation start of the gripper.

The controlling of the robot arm to perform the target task may include performing the target task by rotating the gripper based on the control data on the rotational operation of the gripper.

The magnification determination model may be a model trained to output the target magnification by a reinforcement learning method.

In a general aspect, here is provided a non-transitory, computer-readable storage medium storing instructions that, when executed by a processor, cause the processor to perform the method.

Other features and aspects will be apparent from the following detailed description, the drawings, and the claims.

### BRIEF DESCRIPTION OF THE DRAWINGS

FIG. 1 illustrates an example robot arm control apparatus according to one or more embodiments.

FIG. 2 illustrates an example method with robot arm control according to one or more embodiments.

FIG. 3 illustrates an example process of motion planning by a robot arm control apparatus according to one or more embodiments.

FIG. 4A illustrates an example method with generating a first heatmap image using a first heatmap generation model according to one or more embodiments.

FIG. 4B illustrates an example first heatmap image according to one or more embodiments.

FIG. 5 illustrates an example process of determining a target magnification using a magnification determination model according to one or more embodiments.

FIG. 6A illustrates an example process of generating a second heatmap image using a second heatmap generation model according to one or more embodiments.

FIG. 6B illustrates an example second heatmap image according to one or more embodiments.

FIG. 7 illustrates an example electronic apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

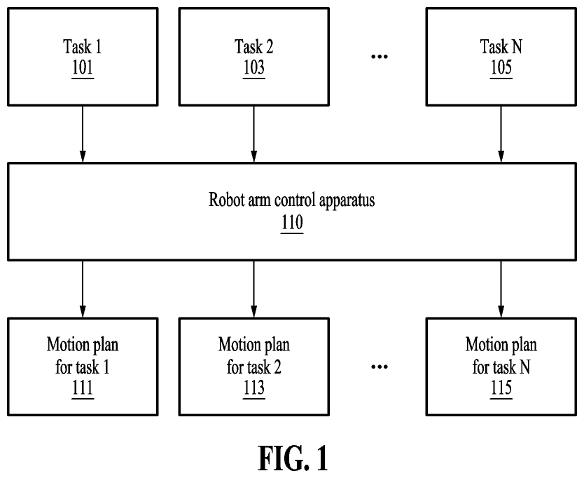

FIG. 1 illustrates an example robot arm control apparatus according to one or more embodiments.

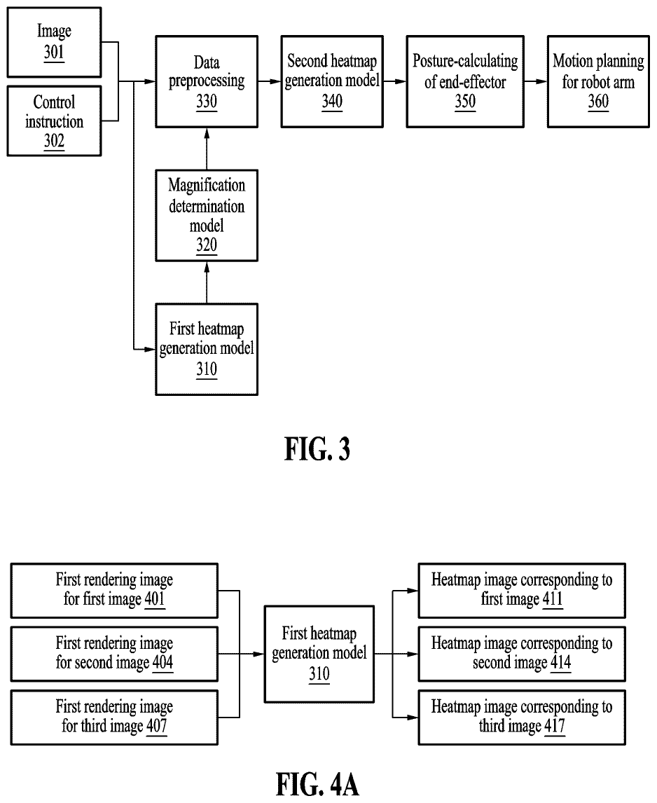

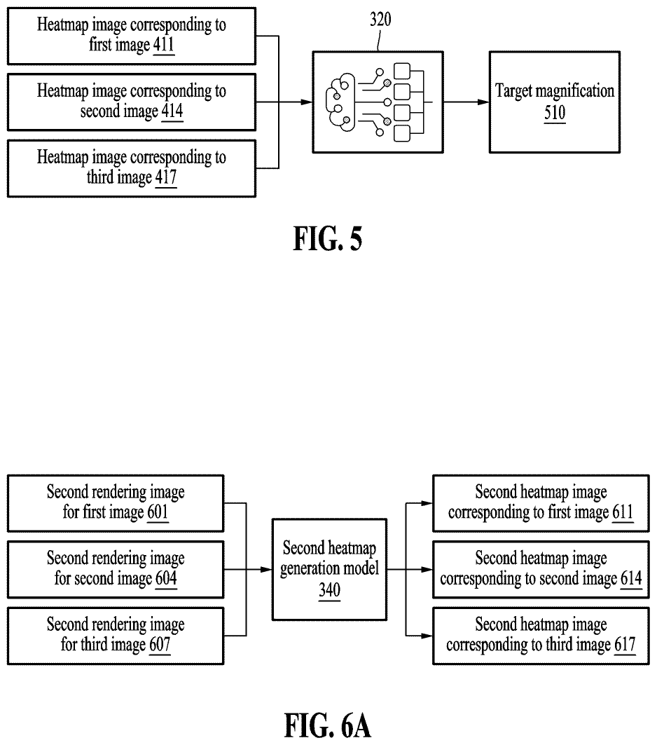

Referring to FIG. 1, in a non-limiting example, a robot arm control apparatus 110 may be a control apparatus for controlling a robot arm to perform a requested task. The task may indicate a problem or goal to be solved using the robot arm. The robot arm control apparatus 110 may magnify and use an input image in the process of performing the requested task. The robot arm control apparatus 110 may use an adaptive scaling technique as a technique for magnifying the input image. The adaptive scaling technique may refer to varying scales depending on requested tasks, rather than using a fixed scale (e.g., a fixed magnification). The robot arm control apparatus 110 may use the adaptive scaling technique and determine a magnification of an input image (e.g., an image 301 of FIG. 3) to be a magnification (e.g., a target magnification 510 of FIG. 5) that is optimized for the requested task.

In an example, adaptive scaling may be performed through an active sensing process. Active sensing may refer to selecting a magnification that is optimized for the requested task and collecting images to which the selected magnification is applied, rather than images to which a fixed magnification is applied. The robot arm control apparatus 110 may determine a magnification that is optimized for each task even when various tasks are requested and may increase the versatility of motion planning using the determined optimized magnification. Motion planning may refer to the robot arm control apparatus 110 estimating the motion of the robotic arm (including the motion of an end-effector) to solve the requested task. The motion of the robot arm may include a path in a space in which the robot arm moves and rotation angles of a plurality of joints included in the robot arm. In addition, the robot arm control apparatus 110 may obtain more detailed information to perform the requested task from the input image to which the optimized magnification is applied and may improve the precision of task performance performed by the robot arm using the obtained detailed information to control the robot arm. The precision of task performance may be a probability value indicating how successfully the requested task is performed when the robot arm performs the requested task. For example, the precision of task performance may be expressed as the number of successes of the requested task for the total number of executions of the requested task of the robot arm.

In an example, the robot arm control apparatus 110 may establish a motion plan in response to the requested task.

The robot arm control apparatus 110 may establish a motion plan (e.g., a motion plan 111 for task 1 and a motion plan 113 for task 2 to a motion plan 115 for task N) corresponding to each task for requested tasks (e.g., task 1 101 and task 2 103 to task N 105). The requested tasks may vary. For example, the task 1 101 may be “close the lid of the jar,” the task 2 103 may be “turn on the light bulb,” or the task N 105 may be “stack the cups.”

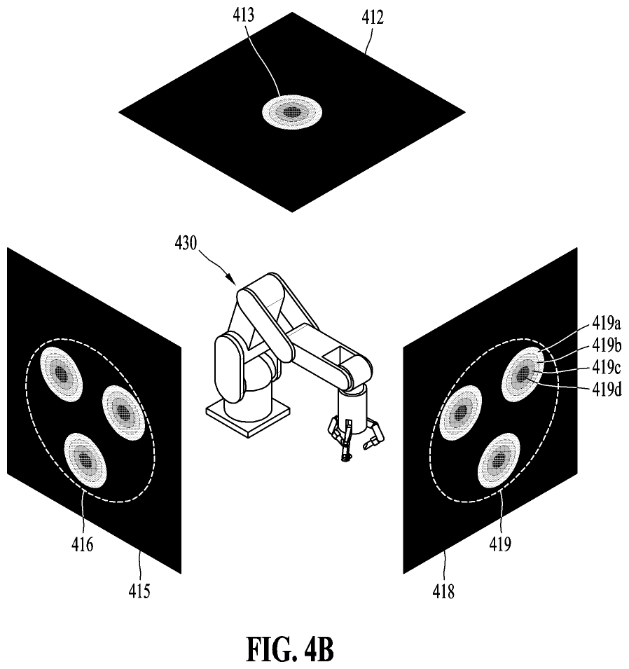

The robot arm control apparatus 110 may obtain or determine a magnification that is optimized for each task to establish a motion plan corresponding to each requested task. The magnification may indicate a ratio of magnifying a region of interest (ROI) in a first rendering image. The first rendering image may indicate an image that is rendered using a point cloud including points indicating a three-dimensional (3D) coordinate of each of pixels indicating the input image and points indicating a 3D coordinate of each of pixels indicating the robot arm image in the input image. The ROI may indicate a region that is extracted (including being selected or cropped) from the first rendering image to process the requested task by the robot arm control apparatus 110. The robot arm control apparatus 110 may obtain the ROI from a first heatmap generation model (e.g., a first heatmap generation model 310 of FIG. 4A). That is, the first heatmap generation model may generate the ROI. The robot arm control apparatus 110 may obtain the magnification from a magnification determination model (e.g., a magnification determination model 320 of FIG. 5).

For example, when the requested task 1 101 is “close the lid of the jar,” the robot arm control apparatus 110 may determine the magnification (e.g., a two-times magnification) from the magnification determination model that takes a first heatmap image as an input. The robot arm control apparatus 110 may magnify the ROI of the first rendering image twice to perform the requested task 1 101. The ROI may be a region including an end-effector of the robot arm and the “lid of the jar” in the first rendering image. For example, the end-effector may be provided on one side of the robot arm and may indicate a part that directly performs the target task. Under the control of the robot arm control apparatus 110, the end-effector may directly perform the target task. For example, the end-effector may be a gripper capable of manipulating an object on which the requested task is to be performed. The gripper may directly perform the target task (e.g., the task 1 101, “close the lid of the jar”) under the control of the robot arm control apparatus 110. When the requested task 2 103 is “turn on the light bulb,” the robot arm control apparatus 110 may obtain the magnification (e.g., 5 times magnification) from the magnification determination model. That is, the magnification determination model may generate or determine the magnification. For example, the robot arm control apparatus 110 may magnify, by 5 times, the ROI of a second image (not shown) that is input to perform the requested task 2 103. The ROI of the first rendering image obtained by rendering the second image may be a region including the end-effector of the robot arm and a “switch to turn on the light bulb.” The obtaining of the magnification by the robot arm control apparatus 110 from the magnification determination model is described in greater detail below with reference to FIG. 5.

In an example, the robot arm control apparatus 110 may establish the motion plan using the input image that is magnified by the magnification. The robot arm control apparatus 110 may establish the motion plan using inverse kinematics. Inverse kinematics may refer to a process of determining a certain position (or posture) of the robot arm (or the end-effector included in the robot arm) to perform the requested task and then calculating the motion of each joint included in the robot arm. For example, when the requested task 1 101 is “close the far lid,” the robot arm control apparatus 110 may determine a target position of the end-effector using the image obtained by twice magnifying the ROI of the first rendering image that is obtained by rendering the input first image and then determine the moving path in the space of the robot arm and the moving angle of each joint included in the robot arm. When the requested task 2 103 is “turn on the light bulb,” the robot arm control apparatus 110 may determine the target position of the end-effector using the image obtained by twice magnifying the ROI of the first rendering image that is obtained by rendering the input second image and then determine the moving path in the space of the robot arm and the moving angle of each joint included in the robot arm. The controlling of the robot arm by the robot arm control apparatus 110 using the motion plan is described in greater detail below with reference to FIG. 3.

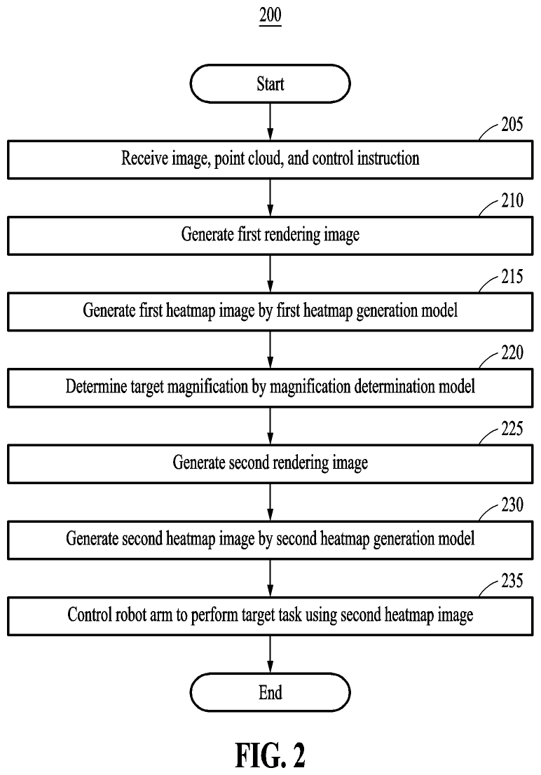

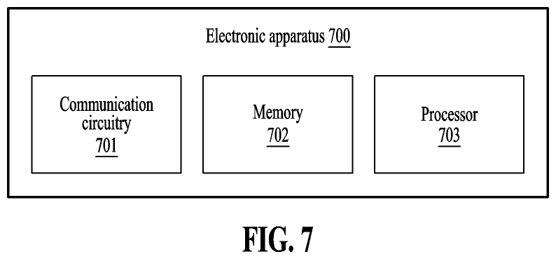

FIG. 2 illustrates an example method with robot arm control according to one or more embodiments. The operations of the robot arm control method may be performed by a robot arm control apparatus (e.g., the robot arm control apparatus 110 of FIG. 1 and an electronic apparatus 700 of FIG. 7).

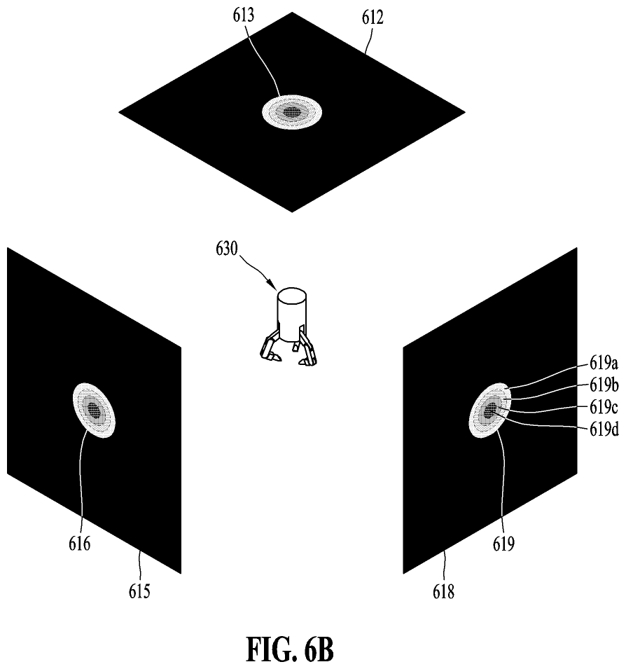

Referring to FIG. 2, in a non-limiting example, method 200 may include operations 210, 215, 220, 225, 230, and 235. In an example, in operation 205, a robot arm control apparatus (e.g., robot control apparatus 110 and/or electronic apparatus 700) may receive an image (e.g., an image 301 of FIG. 3), a point cloud, and a control instruction (e.g., a control instruction 302 of FIG. 3). The robot arm control apparatus may receive an image showing a robot arm having an end-effector (e.g., a gripper 630 of FIG. 6) that performs a target task obtained from an image sensor through a communication circuit (e.g., a communication circuit 701 of FIG. 7), the point cloud including points indicating a 3D coordinate of each of pixels indicating the robot arm in the image, and the control instruction to control the robot arm. The control instruction may include an instruction indicating a task requested by a user. For example, the control instruction may include, but is not limited thereto, instructions such as “close the lid of the jar,” “turn on the light bulb,” or “stack the cups.” The image showing the robot arm having the end-effector that performs the target task may be obtained (e.g., the image may be captured) through the image sensor. The image sensor may include a plurality of image sensors. For example, the image sensor may include a first image sensor that captures the robot arm in a first direction (e.g., a direction in which the robot arm is viewed from above), a second image sensor that captures the robot arm in a second direction (e.g., a direction in which the robot arm is viewed from a side), and a third image sensor that captures the robot arm in a third direction (e.g., a direction of the other side neighboring a side of the robot arm). The robot arm control apparatus may receive a first image from the first image sensor, a second image from the second image sensor, and a third image from the third image sensor. The image sensor may further include, but is not limited thereto, additional sensors, including, for example, a fourth image sensor that captures the robot arm in a fourth direction (e.g., a direction facing a side of the robot arm) and a fifth image sensor that captures the robot arm in a fifth direction (e.g., a direction facing the other side of the robot arm). However, the number of sensors is not limited thereto.

In an example, in operation 210, the robot arm control apparatus (e.g., robot arm control apparatus 110 and/or electronic apparatus 700) may generate a first rendering image. The robot arm control apparatus may generate the first rendering image using the image and the point cloud. The first rendering image may indicate rendering a scene in which the robot arm is viewed from a virtual viewpoint in a virtual space. For example, the robot arm control apparatus may obtain, from the image, color and texture information of the actual robot arm captured by a camera sensor and obtain (i.e., determine) information about the shape of the robot arm through the point cloud. The robot arm control apparatus may generate the first rendering image using the obtained color and texture information of the robot arm and the information about the shape of the robot arm.

In an example, in operation 215, the robot arm control apparatus (e.g., robot arm control apparatus 110 and/or electronic apparatus 700) may generate (or obtain) a first heatmap image (e.g., a heatmap image corresponding to a first image 411) by a first heatmap generation model (e.g., a first heatmap generation model 310). That is, the robot arm control apparatus may generate the first heat map image by the first heatmap generation model. In another example, the robot arm control apparatus may obtain the first heat map image from the first heatmap generation model. The robot arm control apparatus may input the first rendering image and the control instruction to the first heatmap generation model. The first heatmap image may represent an image in which the input first rendering image is expressed in a corresponding color in a defined color range. For example, the first heatmap image may represent an image in which the 3D points of the end-effector included in the first rendering image are expressed in corresponding colors in a defined color range. The first heatmap image may be used to estimate a target position of the end-effector to perform the target task. The first heatmap generation model may represent a machine learning model that generates and outputs the first heatmap image using the input first rendering image. The first heatmap generation model may be a machine learning model based on a transformer model. The first heatmap generation model and the generating of the first heatmap image from the first heatmap generation model are described in greater detail below with reference to FIG. 4A.

The robot arm control apparatus may generate (or obtain) the first heatmap image and a first feature point by the first heatmap generation model. The first feature point may represent a 3D coordinate corresponding to the maximum value among color values of the first heatmap image. For example, the first heatmap image generated by the first heatmap generation model may represent the point cloud in a space in a corresponding color in a defined color range. The defined color may be red, orange, yellow, green, blue, indigo, and purple. Examples of color values may include color values such as a color value corresponding to red may be 0.9, a color value corresponding to orange may be 0.8, a color value corresponding to yellow may be 0.7, a color value corresponding to green may be 0.6, a color value corresponding to blue may be 0.5, a color value corresponding to indigo may be 0.4, and a color value corresponding to purple may be 0.3. The point cloud may include points such as P1(10, 15, 70), P2(13, 17, 65), P3(13, 16, 66), P4(13, 17, 66), P5(14, 16, 73), P6(15, 15, 71), P7(11, 15, 61), and P8(11, 12, 77) in the space. P1 may represent orange, P2 may represent orange, P3 may represent orange, P4 may represent red, P5 may represent yellow, P6 may represent blue, P7 may represent blue, and P8 may represent purple. The first feature point obtained from the first heatmap generation model may represent P4(13, 17, 66), which is a 3D coordinate having the color value of red, which, as shown above, has the highest color value.

The first heatmap generation model may output the first heatmap image and the first feature point using a plurality of rendering images. For example, the rendering image input to the first heatmap generation model may include an image obtained by capturing the robot arm in a first direction (e.g., a direction in which the robot arm is viewed from above), an image obtained by capturing the robot arm in a second direction (e.g., a direction in which the robot arm is viewed from a side), and an image obtained by capturing the robot arm in a third direction (e.g., a direction of the other side neighboring a side of the robot arm). The first heatmap generation model may output the first heatmap image based on a color value of a 2D heatmap image corresponding to a first image, a color value of a 2D heatmap image corresponding to a second image, and a color value of a 2D heatmap image corresponding to a third image. For example, a coordinate of one point in the point cloud may be P(13, 19, 66). In this case, a coordinate corresponding to P(13, 19, 66) on the first image may be Pz(13, 17, 0), a coordinate corresponding to P(13, 19, 66) on the second image may be Px(0, 17, 66), and a coordinate corresponding to P(13, 19, 66) on the third image may be Py(13, 0, 66). When a color value corresponding to Pz(13, 17, 0) on the first image is 0.9, a color value corresponding to Px(0, 17, 66) on the second image is 0.9, and a color value corresponding to Py(13, 0, 66) on the third image is 0.8, a color value of P(13, 19, 66) of the first heatmap image may be 0.867, which is the average of the color value of Pz(13, 17, 0), the color value of Px(0, 17, 66), and the color value of Py(13, 0, 66). The first heatmap generation model may output the first heatmap image by performing the process described above on all points in the point cloud. When the color values corresponding to the points included in the point cloud are smaller than the color value (0.867) of P(13, 19, 66), the first heatmap generation model may output P(13, 19, 66) as the first feature point.

In an example, in operation 220, the robot arm control apparatus (e.g., robot arm control apparatus 110 and/or electronic apparatus 700) may generate (or obtain) a target magnification (e.g., a target magnification 510) by the magnification determination model. The target magnification may indicate the degree to which an ROI associated with the target task is magnified in the first rendering image. There may be no set answer to the magnification when the robot arm is performing a task. When the robot arm performs the task successfully, the magnification applied to the image at that time may be estimated as a magnification suitable for performing the target task. Accordingly, the magnification determination model may be a model trained to generate and output a magnification suitable for the robot arm control apparatus to perform a requested task by a reinforcement learning method, rather than a machine learning model trained by supervised learning or unsupervised learning. For example, the magnification determination model may be a deep Q-network (DQN) model. The magnification determination model is described in greater detail below with reference to FIG. 5.

In an example, the robot arm control apparatus may obtain probability values for each of the different candidate magnifications from the magnification determination model. The robot arm control apparatus may determine, to be the target magnification, a candidate magnification having the largest probability value among the probability values for each of the different candidate magnifications. For example, the magnification determination model may output candidate magnifications of 1, 2, 3, 4, 5, and 6 and the probability values of 0.1, 0.1, 0.2, 0.2, 0.3, and 0.1 for each magnification. The robot arm control apparatus may determine, to be the target magnification, the magnification 5 corresponding to 0.3, which is the largest value among the probability values. The obtaining of the target magnification by the robot arm control apparatus from the magnification determination model is described in greater detail below with reference to FIG. 5.

In an example, in operation 225, the robot arm control apparatus (e.g., robot arm control apparatus 110 and/or electronic apparatus 700) may generate a second rendering image. The robot arm control apparatus may generate the second rendering image in which an ROI is magnified and rendered by applying the target magnification to the ROI of the first rendering image. The generating of the rendering image is described above in operation 210, so any repeated description is omitted. For example, when a task, such as “stack the cups,” is requested to the robot arm control apparatus, the ROI of the first rendering image may be a “region including the end-effector (e.g., a gripper) provided on one side of the robot arm and the cups.” The robot arm control apparatus may generate the second rendering image in which the “region including the end-effector (e.g., the gripper) provided on one side of the robot arm and the cups” in the first rendering image are magnified by the determined magnification (e.g., three times).

In an example, in operation 230, the robot arm control apparatus (e.g., robot arm control apparatus 110 and/or electronic apparatus 700) may generate (or obtain) a second heatmap image by a second heatmap generation model. The robot arm control apparatus may input the second rendering image to the second heatmap generation model (e.g., a second heatmap generation model 340 of FIG. 6A). The second heatmap generation model may correspond to the first heatmap generation model and is described in greater detail below with reference to FIG. 6A. The robot arm control apparatus may obtain the second heatmap image from the second heatmap generation model. The second heatmap image may be used to estimate the target position of the end-effector to perform the target task.

The robot arm control apparatus may obtain the second heatmap image and a second feature point from the second heatmap generation model. The second feature point may represent a 3D coordinate corresponding to the maximum value among color values of the second heatmap image. The obtaining of the second heatmap image and the second feature point from the second heatmap generation model may correspond to obtaining the first heatmap image and the first feature point from the first heatmap generation model as described above in operation 215, so any repeated description is omitted.

The second heatmap generation model may output the second heatmap image and the second feature point using a plurality of second rendering images. The second rendering image input to the second heatmap generation model may be a rendering image generated by applying the target magnification to an ROI of an image obtained by rendering the first image, a rendering image generated by applying the target magnification to an ROI of an image obtained by rendering the second image, and a rendering image generated by applying the target magnification to an ROI of an image obtained by rendering the third image. The second heatmap generation model may generate and output the second heatmap image and the second feature point based on the color values of each rendering image. The outputting of the second heatmap image and the second feature point by the second heatmap generation model may correspond to outputting the first heatmap image and the first feature point by the first heatmap generation model as described above, so any repeated description is omitted.

The robot arm control apparatus may additionally obtain data about the end-effector that directly performs the target task from the second heatmap generation model, in addition to the second heatmap image. The end-effector may include a gripper (e.g., gripper 630) that manipulates an object on which the target task is to be performed. For example, the robot arm control apparatus may obtain, from the second heatmap generation model, the second heatmap image, the second feature point, control data on whether to start an operation of the gripper, and control data on a rotational operation of the gripper. The rotational operation of the gripper may include a rotational operation of at least one of roll, pitch, and yaw. The roll may represent rotational motion around a first axis (e.g., x-axis) of the gripper positioned in a 3D space, the pitch may represent rotational motion around a second axis (e.g., y-axis) of the gripper positioned in a 3D space, and the yaw may represent rotational motion around a third axis (e.g., z-axis) of the gripper positioned in a 3D space. A rotation angle included in the control data on the rotational operation may be one of the predefined rotation angles. For example, the predefined rotation angles may include angles (e.g., 5°, 10°, and 15° to 360°) that divide 360 degrees (°) by 5°.

In an example, in operation 235, the robot arm control apparatus (e.g., robot arm control apparatus 110 and/or electronic apparatus 700) may control the robot arm to perform the target task using the second heatmap image. The control may be based on estimating the target position from the second heat map image. The robot arm control apparatus may improve the precision of the task performed by the robot arm by controlling the robot arm to perform the target task using the second heatmap image. The second heatmap image may be generated by the second heatmap generation model that receives the second rendering image in which the target magnification is applied to the ROI of the first rendering image as an input, whereas the first heatmap image may be generated by the first heatmap generation model that receives the first rendering image as an input. The second rendering image indicating an ROI in which the target magnification is applied to the ROI of the first rendering image may include more information about the ROI than the first rendering image. Including more information about the ROI may indicate including more detailed information about the ROI, and the robot arm control apparatus may control the robot arm to perform the target task more precisely using the detailed information about the ROI.

The robot arm control apparatus may control the robot arm to perform the target task using the second heatmap image and the second feature point. For example, the robot arm control apparatus may control the robot arm to perform the target task by controlling the end-effector provided in the robot arm to move to the second feature point. The end-effector may include the gripper. When the control data on whether to start the operation of the gripper is data indicating an on state indicating an operation start of the gripper, the robot arm control apparatus may control the robot arm so that the gripper is positioned at the second feature point. The robot arm control apparatus may perform the target task by rotating the gripper based on the control data on the rotational operation of the gripper. The robot arm control apparatus may control the robot arm to perform the target task (e.g., “move the ball on the desk 20 cm to the right”) by controlling the gripper to rotate using at least one of roll, pitch, and yaw. For example, the robot arm control apparatus may perform the target task by controlling the gripper to rotate by roll (30°) and pitch (47°) and controlling the rotated gripper to push the ball on the desk 20 cm to the right.

FIG. 3 illustrates an example process of motion planning by a robot arm control apparatus according to one or more embodiments.

Referring to FIG. 3, in a non-limiting example, a robot arm control apparatus (e.g., the robot arm control apparatus 110 of FIG. 1 and/or electronic device 700 of FIG. 7) may perform motion planning on a robot arm based on an image 301 and a control instruction 302. The robot arm control apparatus may receive the image 301 (e.g., a red, green, and blue (RGB) image or an RGB-depth (D)(RGB-D) image) and the control instruction 302 through a communication circuit (e.g., a communication circuit 701 of FIG. 7). The robot arm control apparatus may receive a point cloud including points indicating a 3D coordinate of each of pixels indicating the robot arm in the image 301, in addition to the image 301 and the control instruction 302. The image 301 may be the image 301 showing the robot arm having an end-effector (e.g., gripper 630) that performs a target task. The robot arm control apparatus may input the image 301 and the control instruction 302, which are received, to a first heatmap generation model 310. The first heatmap generation model 310 is a transformer-based machine learning model and may be a machine learning model trained to output a heatmap image using a deep learning-based learning method. The first heatmap generation model 310 is described in greater detail below with reference to FIG. 4A.

The robot arm control apparatus may output a first heatmap image from the first heatmap generation model 310, the first heatmap image corresponding to the image 301 being input to the first heatmap generation model 310. For example, the first heatmap generation model 310, which takes a first rendering image obtained by rendering the image 301 that is input as an input, may output the first heatmap image. The first heatmap image is described in detail above with reference to FIG. 2, so any repeated description is omitted.

The robot arm control apparatus may determine (or obtain) a target magnification by a magnification determination model 320 receiving the first heatmap image as an input. The magnification determination model 320 is a machine learning model and may be a model trained to generate and output the target magnification by a reinforcement learning method. The magnification determination model 320 may output the target magnification that is adaptively determined depending on the type of requested task. The magnification determination model 320 may be trained to output a target magnification suitable for the requested task in the training process of the first heatmap generation model 310 and a second heatmap generation model 340. The magnification determination model 320 is described in greater detail below with reference to FIG. 5.

The robot arm control apparatus may perform preprocessing on the control instruction 302 and an input image. In an example, data preprocessing 330 may include a vectorization process based on embedding natural language included in the control instruction 302. The robot arm control apparatus may tokenize the natural language included in the control instruction 302 and obtain the vectorized natural language from an encoder that inputs the tokenized natural language. The vectorized natural language may be used as an input of the second heatmap generation model 340. The data preprocessing 330 may include preprocessing the input image. The robot arm control apparatus may convert a second rendering image generated using the input image into a data format that is easy for the second heatmap generation model 340 to process. For example, the robot arm control apparatus may convert the second rendering image including 2D information into one-dimensional (1D) data (e.g., a 1D tensor).

The robot arm control apparatus may obtain a second heatmap image from the second heatmap generation model 340 which was generated using the second rendering image. The generating of the second heatmap image using the second rendering image is described in detail above with reference to FIG. 2, so any repeated description is omitted. The second heatmap image may include more detailed information about an ROI to perform the target task than the first heatmap image.

In an example, the robot arm control apparatus may generate (or obtain) a second feature point in addition to the second heatmap image by the second heatmap generation model 340. The robot arm control apparatus may perform posture-calculating of an end-effector 350 using the second heatmap image and the second feature point. The posture-calculating of the end-effector 350 may include at least one of obtaining (or calculating) position data of the end-effector to perform the target task, obtaining (or calculating) data on whether to start an operation of the end-effector, and obtaining (or calculating) control data to control the end-effector. For example, the end-effector may be a gripper, and the gripper may manipulate an object on which the target task is to be performed. The robot arm control apparatus may calculate the second feature point as the next position where the gripper moves and calculate the operations of the gripper to perform the target task by using the control data (e.g., control data on on/off of the operations of the gripper) on whether to start an operation of the gripper positioned at the second feature point and the control data (e.g., data on a rotational operation for at least one of roll, pitch, and yaw) on a rotational operation of the gripper.

In an example, the robot arm control apparatus may perform motion planning of a robot arm 360 using the calculated end-effector posture. For example, the robot arm control apparatus may perform the motion planning of the robot arm 360 by estimating the motion angles of joints of the robot arm through inverse kinematics so that the end-effector is positioned at the second feature point.

FIG. 4A illustrates an example method with generating a first heatmap image using a first heatmap generation model according to one or more embodiments.

Referring to FIG. 4A, in a non-limiting example, a robot arm control apparatus (e.g., the robot arm control apparatus 110 of FIG. 1 and/or electronic device 700 of FIG. 7) may generate (or obtain) a heatmap image corresponding to a first image by a first heatmap generation model (e.g., the first heatmap generation model 310 of FIG. 3) to which a first rendering image is input. A rendering image may include a first rendering image for a first image 401, a first rendering image for a second image 404, and a first rendering image for a third image 407. The heatmap image may include a heatmap image corresponding to a first image 411, a heatmap image corresponding to a second image 414, and a heatmap image corresponding to a third image 417. The generating of the first rendering image for the first image 401, the first rendering image for the second image 404, and the first rendering image for the third image 407 is described in detail above with reference to FIG. 2, so any repeated description is omitted. In addition to an input image, a control instruction may be input to the first heatmap generation model 310 as illustrated above in FIG. 3. The control instruction may include a target task request.

The first heatmap generation model 310 to which the first rendering image for the first image 401, the first rendering image for the second image 404, and the first rendering image for the third image 407 are input may output the heatmap image corresponding to the first image 411, the heatmap image corresponding to the second image 414, and the heatmap image corresponding to the third image 417. The heatmap image is described in detail above with reference to FIG. 2, so any repeated description is omitted.

In an example, the first heatmap generation model 310 may output a feature point in the heatmap image, in addition to the heatmap image. The first heatmap generation model 310 may output a first feature point, which is a 3D coordinate corresponding to the maximum value among color values of the first heatmap image. The first feature point may be input to a second heatmap generation model and used to obtain a second feature point, which is estimated as a final target position of an end-effector. When the first rendering image for the first image 401, the first rendering image for the second image 404, and the first rendering image for the third image 407 are input to the first heatmap generation model 310, the first heatmap generation model 310 may generate and output the first heatmap image using the average values of a color value of a 2D heatmap image corresponding to a first image, a color value of a 2D heatmap image corresponding to a second image, and a color value of a 2D heatmap image corresponding to a third image and may output the largest value among the average values as the first feature point. The generating of each heatmap image using the plurality of first rendering images is described in detail above with reference to FIG. 2, so any repeated description is omitted.

The first heatmap generation model 310 is a machine learning model based on a transformer architecture and may include a plurality of layers. The plurality of layers may include an input layer, an encoder layer, a decoder layer, and an output layer.

The input layer of the first heatmap generation model 310 may tokenize the control instruction (e.g., “stack the cups”). For example, the input layer may tokenize the input control instruction using a byte pair encoding (BPE) algorithm or a wordpiece algorithm. The input layer may output a vector obtained by converting the tokenized control instruction. The input layer may reduce the dimension of the input image. For example, when the input first rendering image is 2D image data, the 2D first rendering image data may be converted into a 1D first rendering image data format (e.g., a 1D tensor). The input layer may convert the control instruction and the input first rendering image, which are input through the above process, into a data format that the encoder may be able to effectively process.

The encoder layer may include at least one encoder including self-attention and feedforward neural networks. The encoder may output a vector to which a relationship information (e.g., contextual information) of the input data obtained from the input layer is added and may extract a feature from the input first rendering image data.

The decoder layer may predict the heatmap image using the result values output from the encoder. For example, the decoder layer may predict the heatmap image using the feature extracted from the first rendering image data and the vector to which the contextual information is added.

The output layer may output a probability distribution for the predicted heatmap image. For example, the output layer may calculate the probability distribution for the predicted heatmap image using a SoftMax function. The output layer may select a heatmap image having the highest probability in the calculated probability distribution and output the selected heatmap image.

The first heatmap generation model 310 may be trained through a supervised learning method or an unsupervised learning method. The process of training the first heatmap generation model 310 may include, for example, a process of preprocessing training data, generating the predicted heatmap image from the first heatmap generation model 310 using the preprocessed training data, and updating parameters of the first heatmap generation model 310 using the predicted heatmap image.

The training data used in the first heatmap generation model 310 may include a training control instruction and a training first rendering image and may further include label data when using supervised learning.

The process of preprocessing the training data may include a tokenization process that divides the input training control instruction into a token unit, a process of reducing the dimension of the input training first rendering image, and a process of normalizing a training point cloud.

The process of generating the predicted heatmap image from the first heatmap generation model 310 may be a process of generating the heatmap image to perform the target task through a process of encoding and decoding the preprocessed training data. The encoding and decoding of the preprocessed training data may be performed by the encoder and the decoder included in the first heatmap generation model 310 based on a transformer model.

The process of optimizing the first heatmap generation model 310 may include a process of determining loss (or a loss function) (e.g., cross-entropy loss) for the predicted values output from the first heatmap generation model 310 and minimizing the determined loss. The process of minimizing the determined loss may include a process of differentiating the loss function to determine how much each parameter of the first heatmap generation model 310 contributes to the loss and updating the parameters according to the degree of contribution. The updating of the parameters may use a gradient descent method or a modified gradient descent method. The first heatmap generation model 310 may have the ability to train a pattern from the training first rendering image through this training process and output the first heatmap image corresponding to the target task.

FIG. 4B illustrates an example first heatmap image according to one or more embodiments.

Referring to FIG. 4B, in a non-limiting example, a robot arm control apparatus (e.g., the robot arm control apparatus 110 of FIG. 1 and/or electronic apparatus 700) may generate heatmap images by a first heatmap generation model to which a first rendering image for a first image (e.g., the first rendering image for the first image 401 of FIG. 4A) obtained by capturing a robot arm 430 in a first side 412, a first rendering image for a second image (e.g., the first rendering image for the second image 404 of FIG. 4A) obtained by capturing the robot arm 430 in a second side 415, and a first rendering image for a third image (e.g., the first rendering image for the third image 407 of FIG. 4A) obtained by capturing the robot arm 430 a third side 418 are input. For example, the first heatmap generation model may obtain a heatmap image corresponding to a first image 413 from the first rendering image for the first image, a heatmap image corresponding to a second image 416 from the first rendering image for the second image, and a heatmap image corresponding to a third image 419 from the first rendering image for the third image. The heatmap image corresponding to the first image 413 may correspond to the heatmap image corresponding to the first image 411 of FIG. 4A, the heatmap image corresponding to the second image 416 may correspond to the heatmap image corresponding to the second image 414 of 4A, and the heatmap image corresponding to the third image 419 may correspond to the heatmap image corresponding to the third image 417 of 4A.

The heatmap image corresponding to the first image 413 may include one color distribution for an end-effector (e.g., a gripper 630 of FIG. 6) of the robot arm 430. The heatmap image may include a region corresponding to a color or color distribution for the end-effector of the robot arm 430 included in a first rendering image. For example, the heatmap image corresponding to the third image 419 may be represented as a red region 419d, an orange region 419c, a green region 419b, and a blue region 419a. The heatmap image corresponding to the second image 416 and the heatmap image corresponding to the third image 419 may be generated by capturing the robot arm 430 in the side on the images obtained by rendering each of a second image and a third image and may include three color distributions for the end-effector of the robot arm 430. Each of the three color distributions may be the same color distribution or different color distributions. For example, when each of the three color distributions represents the same color distribution, each color distribution may include the red region 419d, the orange region 419c, the green region 419b, and the blue region 419a. When the first heatmap image for the end-effector of the robot arm 430 has a plurality of color distributions, such as the first heatmap image corresponding to the second image 416 and the heatmap image corresponding to the third image 419, there may be a plurality of the number of feature points that becomes the next position of the end-effector which may reduce the precision of task performance of the robot arm 430. The moving of the end-effector to the position of the feature point by the robot arm control apparatus using the heatmap image is described in detail above with reference to FIG. 2, so any repeated description is omitted.

FIG. 5 illustrates an example process of determining a target magnification using a magnification determination model according to one or more embodiments.

Referring to FIG. 5, in a non-limiting example, the magnification determination model 320, which takes a first heatmap image (e.g., the heatmap image corresponding to the first image 411 of FIG. 4A) as an input, may output a target magnification 510. The first heatmap image may include the heatmap image corresponding to the first image 411, the heatmap image corresponding to the second image 414, and the heatmap image corresponding to the third image 417. The target magnification 510 may indicate the degree to which an ROI associated with a target task is magnified in a first rendering image. The magnification determination model 320 may output probability values for each of candidate magnifications having different values. A robot arm control apparatus (e.g., robot arm control apparatus 110 and/or electronic apparatus 700) may determine, to be the target magnification 510, a candidate magnification having the largest probability value among the probability values for each of the candidate magnifications having the different values. The determining of the target magnification 510 from the candidate magnifications having the different values is described in detail above with reference to FIG. 2, so any repeated description is omitted.

In an example, the magnification determination model 320 may be a model (e.g., a DQN model) trained to output the target magnification 510 by a reinforcement learning method. Hereinafter, the description of the magnification determination model 320 is provided on the assumption that the magnification determination model 320 is a DQN model. The magnification determination model 320 may include an input layer, a hidden layer, and an output layer. Since the magnification determination model 320 is a model based on a reinforcement learning-based training method, input data may be referred to as a state. The first heatmap image generated by (or obtained from) a first heatmap generation model may be input to the input layer. Preprocessing may be performed on the input layer to compress and/or vectorize the first heatmap image. The hidden layer may extract a state feature from the vectorized data using an activation function (e.g., rectified linear unit (ReLU) or hyperbolic tangent (Tan h)) and may generate and output a value corresponding to the extracted feature. The output layer may provide, among the output values, an output value having the highest probability value as the target magnification 510 or may output the candidate magnifications and probability values corresponding to the candidate magnifications.

The magnification determination model 320 may be trained in the process of training the first heatmap generation model and a second heatmap generation model based on reinforcement learning. The process of training the magnification determination model 320 is as follows.

In an example, a training heatmap image and training feature point may be input as training data for training the magnification determination model 320 based on reinforcement learning. The magnification determination model 320 may output the one training target magnification among the candidate magnifications (e.g., 1, 2, 3, 4, 5, and 6). The magnification determination model 320 may be trained to output the target magnification 510, which is optimal for a requested task, through a process of optimizing the magnification determination model 320 to receive a greater reward for the output training target magnification. The reward may be defined using an error in a position value of an end-effector on a second heatmap image. For example, the reward may be expressed by Equation 1 below.

$$- {‖ {t}_{2} - {t}_{gt} ‖}_{2} \qquad Equation 1$$

In Equation 1, t₂ denotes a position of the end-effector on the second heatmap image and t_{gt} denotes a ground truth (GT) position of the end-effector on the second heatmap image. The GT position may be referred to as a reference position or a label position. The reward may be defined as a negative value for an L2 norm between t₂ and t_{gt}, such as −∥t₂−t_{gt}∥₂. That is, the reward may be defined as a and negative value for a Euclidean distance between t₂ and t_{gt}.

The magnification determination model 320 may train a pattern from the training heatmap image through this training process and may have the ability to output the target magnification 510 that may perform a newly input request task well by maximizing the reward.

FIG. 6A illustrates an example process of generating a second heatmap image using a second heatmap generation model according to one or more embodiments.

Referring to FIG. 6A, in a non-limiting example, a second heatmap image output from the second heatmap generation model 340 may be a heatmap image for a second rendering image. The second rendering image may be a rendering image in which an ROI is magnified and rendered by applying a target magnification to a first rendering image. In contrast, a first heatmap image (e.g., the heatmap image corresponding to the first image 411) output from the first heatmap generation model 310 of FIG. 4A may be a heatmap image for the first rendering image. The first rendering image may represent a rendering image in which an ROI is not magnified or a rendering image in which an ROI is magnified by a magnification that is different from a target magnification obtained (e.g., generated) from a magnification determination model.

The second heatmap generation model 340, which takes the second rendering image as an input, may generate and output the second heatmap image. The second rendering image may include a second rendering image for a first image 601, a second rendering image for a second image 604, and a second rendering image for a third image 607. The second rendering image for the first image 601 may represent a second rendering image in which an ROI is magnified by applying the target magnification to an ROI of the first rendering image generated using a first image. The second rendering image for the second image 604 may represent a second rendering image in which an ROI is magnified by applying the target magnification to an ROI of the first rendering image generated using a second image. The second rendering image for the third image 607 may represent a second rendering image in which an ROI is magnified by applying the target magnification to an ROI of the first rendering image generated using a third image.

The second heatmap generation model 340, which takes the second rendering image as an input, may output the second heatmap image. The second heatmap image may include a second heatmap image corresponding to a first image 611, a second heatmap image corresponding to a second image 614, and a second heatmap image corresponding to a third image 617. The second heatmap image may be used to estimate a final target position of an end-effector to perform a target task. The second heatmap generation model 340 may output the second heatmap image and a second feature point, which is a 3D coordinate corresponding to the maximum value among color values of the second heatmap image. The second heatmap generation model 340 may obtain the second heatmap image using a plurality of second rendering images, similar to the first heatmap generation model 310 to which the plurality of first rendering images is input in FIG. 4A.

The second heatmap generation model 340 to which the plurality of second rendering images is input may obtain the second heatmap image corresponding to the first image 611, the second heatmap image corresponding to the second image 614, and the second heatmap image corresponding to the third image 617 and may output the second feature point using an average of the color values of each of the second heatmap images. For example, the second heatmap generation model 340 may output, as the second feature point, the largest value among the average values of a color value of a heatmap image for a rendering image generated by applying the target magnification to an ROI of an image obtained by rendering the first image, a color value of a heatmap image for a rendering image generated by applying the target magnification to an ROI of an image obtained by rendering the second image, and a color value of a heatmap image for a rendering image generated by applying the target magnification to an ROI of an image obtained by rendering the third image.

The structure of the second heatmap generation model 340 and training the second heatmap generation model 340 may correspond to the structure of the first heatmap generation model 310 and training the first heatmap generation model 310 of FIG. 4A, so any repeated description is omitted. Improving the precision of a task by a robot arm control apparatus by controlling a robot arm using the second heatmap image and the second feature point is described in greater detail below with reference to FIG. 6B.

FIG. 6B illustrates an example second heatmap image according to one or more embodiments.

Referring to FIG. 6B, in a non-limiting example, a robot arm control apparatus (e.g., the robot arm control apparatus 110 of FIG. 1 and/or electronic apparatus 700) may generate (or obtain) second heatmap images (e.g., the second heatmap image corresponding to the first image 611 of FIG. 6A, the second heatmap image corresponding to the second image 614 of FIG. 6A, and the second heatmap image corresponding to the third image 617 of FIG. 6A) by a second heatmap generation model that receives a second rendering image for a first image obtained by capturing a gripper 630 in a first direction 612 (e.g., the second rendering image for the first image 601 of FIG. 6A), a second rendering image for a second image obtained by capturing the gripper 630 in a second direction 615 (e.g., the second rendering image for the second image 604 of FIG. 6A), and a second rendering image for a third image obtained by capturing the gripper 630 in a third direction 618 (e.g., the second rendering image for the third image 607 of FIG. 6A) as inputs.

For example, a second heatmap image 613 in the first direction 612, a second heatmap image 616 in the second direction 615, and a second heatmap image 619 in the third direction 618 may include one color distribution for an end-effector (e.g., the gripper 630). Hereinafter, the description is based on the assumption that the end-effector is the gripper 630, however, examples are not limited thereto and other implements for the robot arm (e.g., a welding tool) may be assessed with the second heat map images. The second heatmap image may be displayed as a region corresponding to a color or color distribution. For example, the second heatmap image 619 in the third direction 618 may include one color distribution region (a red region 619d, an orange region 619c, a green region 619b, and a blue region 619a). Each of the second heatmap image 616 in the second direction 615 and the second heatmap image 619 in the third direction 618 may also include one color distribution region. Unlike the heatmap image corresponding to the second image 416 and the heatmap image corresponding to the third image 419 of FIG. 4B, the second heatmap images may all include one color distribution.

In an example, the robot arm control apparatus may determine a region, which is considered as one point or one region having the highest color value in a space, to be a second feature point using one color distribution. When multiple (e.g., three) identical color distributions appear in one heatmap image, as shown in the first heatmap image, the precision of task performance may be reduced because a plurality of first feature points is provided and a target adjustment position of the end-effector is not determined to be one. In contrast, when one color distribution appears in one heatmap image, as shown in the second heatmap image, the second feature point may be determined to be one. When the second feature point is singular (i.e., only one), the robot arm control apparatus may determine the target adjustment position of the end-effector to be one, thereby improving the precision of task performance. The robot arm control apparatus may generate a first rendering image using an input image and determine a target magnification for an ROI of the first rendering image using the first heatmap image for the first rendering image. The robot arm control apparatus may generate a second rendering image in which an ROI is magnified and rendered by applying the target magnification to the ROI of the first rendering image, generate a second heatmap image for the second rendering image, and finally perform a more precise task using the second heatmap image.

FIG. 7 illustrates an example electronic apparatus according to one or more embodiments.

Referring to FIG. 7, an electronic apparatus 700 may include communication circuitry 701, a memory 702, and a processor 703. The robot arm control apparatus 700 may correspond to the robot arm control apparatus (e.g., robot control apparatus 110) described herein. That is, operations of the robot arm control apparatus may be embodied by the electronic device 700 where its operations may be performed, for example, by the processor 703.

The communication circuitry 701 may communicate using a direct (e.g., wired) communication channel or a wireless communication channel between the robot arm control apparatus 700 and an external electronic device (e.g., a user terminal device). The communication circuitry 701 may include one or more communication processors that operate independently of the processor 703 and support direct (e.g., wired) or wireless communication. The communication circuitry 701 may be implemented as a single chip or as a plurality of chips. The communication circuitry 701 may receive an image showing a current position of a robot arm and a control instruction to control the robot arm. For example, the communication circuitry 701 may receive the image obtained by capturing the robot arm obtained through a sensor and receive the control instruction to control the robot arm from a server device (e.g., a central server device).

The memory 702 may include computer-readable instructions. The processor 703 may be configured to execute computer-readable instructions, such as those stored in the memory 702, and through execution of the computer-readable instructions, the processor 703 may be configured to perform one or more, or any combination, of the operations and/or methods described herein, such as a robot arm control method. The memory 702 may be integrated with a processor. For example, random-access memory (RAM) or flash memory may be integrated with a processor like an integrated circuit microprocessor. The memory 702 may include a separate device, such as a storage device that may be used by an external disk drive, a storage array, or a database system. The memory 702 and the processor 703 may be operatively integrated or may communicate with each other via an input/output (I/O) port, a network connection, or the like so that the processor 703 may read a file stored in the memory 702. The memory 702 may be a non-transitory computer-readable storage medium that stores instructions. When executed by the processor 703, the instructions stored in the memory 702 may prompt at least one processor to cause the robot arm control apparatus 700 to perform the robot arm control method.

The processor 703 may be configured to execute programs or applications to configure the processor 703 to control the electronic apparatus 700 to perform one or more or all operations and/or methods involving the control of a robotic arm, and may include any one or a combination of two or more of, for example, a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof. When the instructions are executed by the processor 703, the processor 703 may control the robot arm control apparatus 700 to perform operations of the robot arm control method described in the present disclosure.

The robot arm control apparatus 700 may include at least one processor including processing circuitry, communication circuitry configured to receive, from an image sensor, an image of a robot arm including an end-effector, a point cloud including points indicating a three-dimensional (3D) coordinate of each of pixels indicating the robot arm in the image, and a control instruction to control the robot arm to perform a target task, and a memory including one or more storage media storing instructions that, when executed individually or collectively by the at least one processor, cause the device to render a scene in which the robot arm is viewed from a virtual viewpoint in a virtual space by using the image and the point cloud to generate a first rendering image, generate a first heatmap image for estimating a target position of the end-effector to perform the target task by a first heatmap generation model receiving the first rendering image and the control instruction, determine a target magnification indicating a degree to which a region of interest (ROI) associated with the target task is magnified in the first rendering image by using a magnification determination model receiving the first heatmap image, generate a second rendering image in which the ROI is magnified and rendered by applying the target magnification to the ROI of the first rendering image, generate a second heatmap image for estimating the target position of the end-effector to perform the target task by a second heatmap generation model receiving the second rendering image, and control the robot arm by estimating the target position to perform the target task using the second heatmap image.

The robot arm control apparatus 700 may generate probability values for each of different candidate magnifications by the magnification determination model and determine, to be the target magnification, a candidate magnification having a largest probability value among the probability values for each of the different candidate magnifications.

The robot arm control apparatus 700 may generate the first heatmap image and a first feature point, the first feature point being a 3D coordinate corresponding to a maximum value among color values of the first heatmap image, by the first heatmap generation model, generate the second heatmap image and a second feature point, the second feature point being a 3D coordinate corresponding to a maximum value among color values of the second heatmap image, by the second heatmap generation model receiving the second rendering image and the first feature point, and control the robot arm by estimating the target position to perform the target task using the second heatmap image and the second feature point.

The image sensor of the robot arm control apparatus 700 may include a first image sensor configured to obtain a first image obtained by capturing the robot arm in a first direction, a second image sensor configured to obtain a second image by capturing the robot arm in a second direction, and a third image sensor configured to obtain a third image by capturing the robot arm in a third direction, the first heatmap generation model may be configured to output the first heatmap image and the first feature point based on a first color value of a two-dimensional (2D) heatmap image corresponding to a first rendered image obtained by rendering the first image, a second color value of a 2D heatmap image corresponding to a second rendered image obtained by rendering the second image, and a third color value of a 2D heatmap image corresponding to a third rendered image obtained by rendering the third image. The second heatmap generation model of the robot arm control apparatus 700 may be configured to output the second heatmap image and the second feature point based on a first heatmap color value of a first heatmap image for a first rendering image generated by applying the target magnification to the ROI of the image obtained by rendering the first image, a second heatmap color value of a second heatmap image for a second rendering image generated by applying the target magnification to the ROI of the image obtained by rendering the second image, and a third heatmap color value of a third heatmap image for a third rendering image generated by applying the target magnification to the ROI of the image obtained by rendering the third image.

The end-effector of the robot arm control apparatus 700 may include a gripper configured to manipulate an object on which the target task is to be performed. The robot arm control apparatus 700 may generate the second heatmap image, the second feature point, control data on whether to start an operation of the gripper, and control data on a rotational operation of the gripper by the second heatmap generation model.

The rotational operation of the gripper of the robot arm control apparatus 700 may include a rotational operation for at least one of roll, pitch, and yaw, in which a rotation angle included in the control data on the rotational operation of the gripper may be one of predefined rotation angles.

The robot arm control apparatus 700 may control the robot arm to position the gripper at the second feature point when the control data on whether to start the operation of the gripper indicates an on state indicating an operation start of the gripper.

The robot arm control apparatus 700 may perform the target task by rotating the gripper based on the control data on the rotational operation of the gripper.

The magnification determination model of the robot arm control apparatus 700 may be a model trained to output the target magnification by a reinforcement learning method.

The robotic arms, electronic devices, processors, memories, neural networks, robot arm control apparatus 110, first heatmap generation model 310, magnification determination model 320, second heatmap generation model 340, robot arm 430, electronic device 700, communication circuitry 701, memory 702, and processor 703 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus, the apparatus comprising:
at least one processor comprising processing circuitry;
communication circuitry configured to receive, from an image sensor, an image of a robot arm including an end-effector, a point cloud comprising points indicating a three-dimensional (3D) coordinate of each of pixels indicating the robot arm in the image, and a control instruction to control the robot arm to perform a target task; and
a memory comprising one or more storage media storing instructions that, when executed individually or collectively by the at least one processor, cause the apparatus to:
render a scene in which the robot arm is viewed from a virtual viewpoint in a virtual space by using the image and the point cloud to generate a first rendering image;
generate a first heatmap image for estimating a target position of the end-effector to perform the target task by a first heatmap generation model receiving the first rendering image and the control instruction;
determine a target magnification indicating a degree to which a region of interest (ROI) associated with the target task is magnified in the first rendering image by using a magnification determination model receiving the first heatmap image;
generate a second rendering image in which the ROI is magnified and rendered by applying the target magnification to the ROI of the first rendering image;
generate a second heatmap image for estimating the target position of the end-effector to perform the target task by a second heatmap generation model receiving the second rendering image; and
control the robot arm by estimating the target position to perform the target task using the second heatmap image.

2. The apparatus of claim 1, wherein the execution of the instructions causes the apparatus to:
generate probability values for each of different candidate magnifications by the magnification determination model; and
determine, to be the target magnification, a candidate magnification having a largest probability value among the probability values for each of the different candidate magnifications.

3. The apparatus of claim 1, wherein the execution of the instructions causes the apparatus to:
generate the first heatmap image and a first feature point, the first feature point being a 3D coordinate corresponding to a maximum value among color values of the first heatmap image, by the first heatmap generation model;
generate the second heatmap image and a second feature point, the second feature point being a 3D coordinate corresponding to a maximum value among color values of the second heatmap image, by the second heatmap generation model receiving the second rendering image and the first feature point; and
control the robot arm by estimating the target position to perform the target task using the second heatmap image and the second feature point.

4. The apparatus of claim 3, wherein the image sensor comprises:
a first image sensor configured to obtain a first image by capturing the robot arm in a first direction, a second image sensor configured to obtain a second image by capturing the robot arm in a second direction, and a third image sensor configured to obtain a third image by capturing the robot arm in a third direction,
wherein the first heatmap generation model is configured to output the first heatmap image and the first feature point based on a first color value of a two-dimensional (2D) heatmap image corresponding to a first rendered image obtained by rendering the first image, a second color value of a 2D heatmap image corresponding to a second rendered image obtained by rendering the second image, and a third color value of a 2D heatmap image corresponding to a third rendered image obtained by rendering the third image, and
wherein the second heatmap generation model is configured to output the second heatmap image and the second feature point based on a first heatmap color value of a first heatmap image for a first rendering image generated by applying the target magnification to the ROI of the image obtained by rendering the first image, a second heatmap color value of a second heatmap image for a second rendering image generated by applying the target magnification to the ROI of the image obtained by rendering the second image, and a third heatmap color value of a third heatmap image for a third rendering image generated by applying the target magnification to the ROI of the image obtained by rendering the third image.

5. The apparatus of claim 3, wherein the end-effector comprises a gripper configured to manipulate an object on which the target task is to be performed, and
wherein the execution of the instructions causes the apparatus to:
generate the second heatmap image, the second feature point, control data on whether to start an operation of the gripper, and control data on a rotational operation of the gripper by the second heatmap generation model.

6. The apparatus of claim 5, wherein the rotational operation comprises a rotational operation for at least one of roll, pitch, and yaw, and
wherein a rotation angle comprised in the control data on the rotational operation of the gripper is one of predefined rotation angles.

7. The apparatus of claim 5, wherein the execution of the instructions causes the apparatus to:
control the robot arm to position the gripper at the second feature point when the control data on whether to start the operation of the gripper indicates an on state indicating an operation start of the gripper.

8. The apparatus of claim 5, wherein the execution of the instructions causes the apparatus to:
perform the target task by rotating the gripper based on the control data on the rotational operation of the gripper.

9. The apparatus of claim 1, wherein the magnification determination model is a model trained to output the target magnification by a reinforcement learning method.

10. A processor-implemented method, the method comprising:
receiving an image, from an image sensor, of a robot arm including an end-effector that, a point cloud comprising points indicating a three-dimensional (3D) coordinate of each of pixels indicating the robot arm in the image, and a control instruction to control the robot arm to perform a target task;
rendering a scene in which the robot arm is viewed from a virtual viewpoint in a virtual space by using the image and the point cloud to generate a first rendering image;
generating a first heatmap image for estimating a target position of the end-effector to perform the target task in the first rendering image by a first heatmap generation model receiving the first rendering image and the control instruction;
determining a target magnification indicating a degree to which a region of interest (ROI) associated with the target task is magnified in the first rendering image by using a magnification determination model receiving the first heatmap image;
generating a second rendering image in which the ROI is magnified and rendered by applying the target magnification to the ROI of the first rendering image;
generating a second heatmap image for estimating the target position of the end-effector to perform the target task in the second rendering image by a second heatmap generation model receiving the second rendering image; and
controlling the robot arm by estimating the target position to perform the target task using the second heatmap image.

11. The method of claim 10, wherein the determining of the target magnification comprises:
generating probability values for each of different candidate magnifications by the magnification determination model; and
determining, to be the target magnification, a candidate magnification having a largest probability value among the probability values for each of the different candidate magnifications.

12. The method of claim 10, wherein the generating of the first heatmap image comprises:
generating the first heatmap image and a first feature point, the first feature point being a 3D coordinate corresponding to a maximum value among color values of the first heatmap image, by the first heatmap generation model,
wherein the generating of the second heatmap image comprises:
generating the second heatmap image and a second feature point, the second point feature being a 3D coordinate corresponding to a maximum value among color values of the second heatmap image, by the second heatmap generation model receiving the second rendering image and the first feature point, and
wherein the controlling of the robot arm to perform the target task comprises:
controlling the robot arm by estimating the target position to perform the target task using the second heatmap image and the second feature point.

13. The method of claim 12, wherein the image sensor comprises:
a first image sensor configured to obtain a first image by capturing the robot arm in a first direction, a second image sensor configured to obtain a second image by capturing the robot arm in a second direction, and a third image sensor configured to obtain a third image by capturing the robot arm in a third direction,
wherein the first heatmap generation model is configured to output the first heatmap image and the first feature point based on a first color value of a two-dimensional (2D) heatmap image corresponding to a first rendered image obtained by rendering the first image, a second color value of a 2D heatmap image corresponding to a second rendered image obtained by rendering the second image, and a third color value of a 2D heatmap image corresponding to a third rendered image obtained by rendering the third image, and
wherein the second heatmap generation model is configured to output the second heatmap image and the second feature point based on a first heatmap color value of a first heatmap image for a first rendering image generated by applying the target magnification to the ROI of the image obtained by rendering the first image, a second heatmap color value of a second heatmap image for a second rendering image generated by applying the target magnification to the ROI of the image obtained by rendering the second image, and a third heatmap color value of a third heatmap image for a third rendering image generated by applying the target magnification to the ROI of the image obtained by rendering the third image.

14. The method of claim 12, wherein the end-effector comprises a gripper configured to manipulate an object on which the target task is to be performed, and
wherein the generating of the second heatmap image comprises:
generating the second heatmap image, the second feature point, control data on whether to start an operation of the gripper, and control data on a rotational operation of the gripper by the second heatmap generation model.

15. The method of claim 14, wherein the rotational operation comprises a rotational operation for at least one of roll, pitch, and yaw, and
wherein a rotation angle comprised in the control data on the rotational operation of the gripper is one of predefined rotation angles.

16. The method of claim 14, wherein the controlling of the robot arm to perform the target task comprises:
controlling the robot arm to position the gripper at the second feature point when the control data on whether to start the operation of the gripper indicates an on state indicating an operation start of the gripper.

17. The method of claim 14, wherein the controlling of the robot arm to perform the target task comprises:
performing the target task by rotating the gripper based on the control data on the rotational operation of the gripper.

18. The method of claim 10, wherein the magnification determination model is a model trained to output the target magnification by a reinforcement learning method.

19. A non-transitory, computer-readable storage medium storing instructions that, when executed by a processor, cause the processor to perform the method of claim 10.
